(19) United States
(12) Patent Application Publication
(10) Pub. No.: US 2004/0158476 A1
(43) Pub. Date: Aug. 12, 2004

(54) Systems and methods for motor vehicle learning management

(75) Inventors: Dennis Blessinger, Sandy, UT (US); Justin J. Boyle, Park City, UT (US); Richard L. Currier, Oceanside, CA (US); David Michael Holdsworth, Sandy, UT (US); Isaac Roach, Taylorsville, UT (US); Nicholas A. Smith, Alpine, UT (US); Mark E. Stulga, Irwin, PA (US); Darrell R. Turpin, South Jordan, UT (US); Reginald T. Welles, Salt Lake City, UT (US)

Correspondence Address: Daniel P. McCarthy, PARSONS, BEHLE & LATIMER, 201 South Main Street, Suite 1800, P.O. Box 45898, Salt Lake City, UT, 84145-0898, US

(73) Assignee: I-SIM, LLC

(21) Appl. No.: 10/360,249

(22) Filed: Feb. 6, 2003

(51) Int. Cl. G06F 17/60

(52) U.S. Cl. 705/1; 705/8; 705/9

(57) ABSTRACT

Systems and methods for training students in a tripartite curriculum of ground vehicle learning are provided. The tripartite curriculum includes computer based testing, training on a simulator, and instructor-led classroom training. Such systems may be referred to as integrated learning systems (ILS).

### BACKGROUND

The subject matter disclosed herein relates to motor vehicular handling and safety training and simulator systems, and more particularly relate to systems which can guide and track a trainee through a curriculum of motor vehicular training courses, those courses including a simulator module component. A tripartite curriculum is provided that includes computer based testing, training on a ground vehicle driving simulator, and instructor-led classroom training. Such systems may be referred to as integrated learning systems (ILS).

Earlier vehicular training systems have included instructor led training, in which an instructor trains trainees in vehicular skills. Traditionally such instructor led training has included lectures, written examinations, and hands-on real vehicle practice. Some earlier systems have included computer-based training, in which a computer presentation is provided to trainees. In some cases computer based training may also include an examination, which is usually multiple-choice and automatically scored in software. Some earlier systems have included simulator training, in which a trainee is placed in a simulated vehicular environment and exposed to various learning situations with the object of instructing the trainee in various vehicular skills. In those earlier systems the tracking of scores, if scores were used at all, was largely a manual activity, requiring a person to transfer the scores into a file.

Many of the earlier simulator systems were geared to training a few individuals who operated very expensive equipment, for example pilots operating fighter jets. In those situations the cost of maintaining trainee scores is negligible in comparison to the expense of the simulator equipment and the risk of damaging or destructing the simulated equipment. In contrast, the employers of motor vehicle operators, such as truck drivers, police officers, forklift operators, and others typically do not have a large budget to devote to driver training. Consequently, in the past such drivers were excluded from being subjects of training on a simulator.

Recently it has been possible to construct motor vehicular simulators with a greatly reduced expense, generally utilizing non-specialized components from multiple sources. With that development it has become more feasible to train the larger population of motor vehicle drivers, such as tractor-trailer drivers and law enforcement officers. Systems and methods disclosed herein further reduce the cost of training by reducing the need for manual management of trainee records and scores, and by reducing the need for manual scoring of trainees through automatic scoring. In addition, more effective training is offered through use of the systems and methods disclosed herein. Thus through these systems and methods, training of motor vehicle operators using simulation equipment has been brought within the budgetary constraints of organizations employing those operators, and effectiveness of that training has been improved.

### BRIEF SUMMARY

Systems and methods for training students in a tripartite curriculum of ground vehicle handling and safety learning are provided. The tripartite curriculum includes computer based testing, training on a ground vehicle driving simulator, and instructor-led classroom training. Such systems may be referred to as integrated learning systems (ILS).

### BRIEF DESCRIPTION OF THE DRAWINGS

FIG. 1 depicts a driving instruction system that includes CBT, SIM and ILT.

FIG. 2 depicts a training system using an LMS.

FIG. 3 depicts an alternate training system including an LMS.

FIG. 4 depicts a training system in which the LMS communicates via a workstation.

FIG. 5 depicts relation between an LMS system and a simulator.

FIG. 6 depicts a system including an LMS and two display and input consoles.

FIG. 7 depicts a system including an LMS system, a simulator, a CBT workstation, and a Remote LMS Workstation.

FIGS. 8-11 depict process steps for methods for training a trainee in courses of a motor vehicular training curriculum.

FIG. 12 depicts an example driver training curriculum matrix.

FIG. 13 depicts an example ground vehicle driving simulator.

### DETAILED DESCRIPTION

Systems and methods described herein permit a learning management system (LMS) to initiate, control and synchronize comprehensive testing and scoring of driver trainees. In those systems as well as other systems described herein, a tripartite curriculum of driver education is offered: computer based training (CBT), training on a ground vehicle driving simulator (SIM), and instructor-led classroom training (ILT). Such systems may be referred to as integrated learning systems (ILS). Modes of training are described in greater detail below.

One mode of driver education is called cognitive information comprehension. In one basic form of this mode of education a trainee is presented with a lesson after which he is tested. The intent of this training mode is to provide information to the trainee to be considered in a cognitive fashion. Cognitive information comprehension may be performed through CBT.

A second mode of driver education is referred to as psychomotor skills demonstration. In that mode of education a trainee is placed in one or more situations, which generally provides training at a practical or intuitive level. In some of the systems and methods this mode of education uses a motor vehicle simulator.

A third mode of driver education is referred to as social affective learning. In that mode of education the trainee learns by presentation of and interaction with an instructor (ILT). Training using that mode provides traditional classroom benefits, such as the ability to ask questions of the instructor or to converse with classroom peers, which may not be available through the other two education modes.

Some systems and methods can manage and/or automate the delivery of some or all three modes of instruction to trainees, and automate the scoring of each trainee's performance in one or more of those three types of training. By utilizing the three modes of instruction, the skills and behaviors of trainees are improved, and the trainees have better retention of the material learned. The long-term goals of these activities include accident reduction and fuel consumption reduction. These systems and methods may be improved by introducing an LMS to some or all three modes. In operation those systems and methods can combine all the learning records and skills performance scores developed by each trainee throughout a comprehensive training course that includes all three modes of learning instruction. This can provide, in automatic fashion if desired, a comprehensive assessment of driver skill and capability to perform various driving tasks. In those systems the LMS controls the courseware of computer-based training (CBT) to test cognitive information comprehension. It can additionally control simulator-based (SIM) scenario exercises to test the demonstration of psychomotor skills, and it can direct, solicit, record and evaluate both the trainer and trainee responses during instructor-led (ILT) coursework to measure social affective learning. Further, the LMS of some of those systems and methods could automatically adjust the content of the CBT courseware and the SIM scenario exercises if desired, or the CBT content could remain static for each course subject matter.

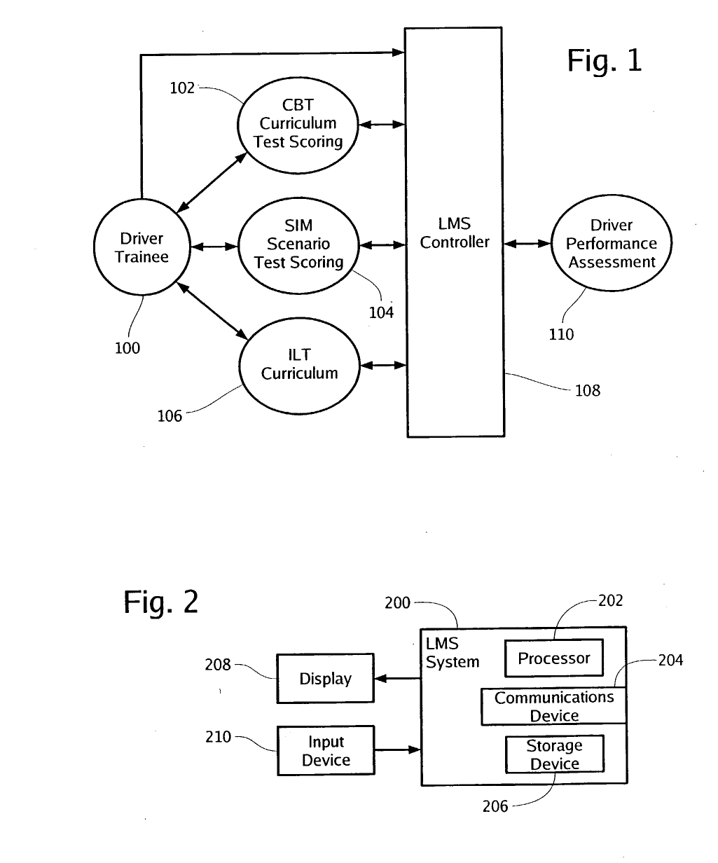

Referring now to FIG. 1, a driving instruction system and products are represented at a high level. A driver trainee 100 is entered into an LMS 108 by the trainee providing at least a unique tracking identifier. The trainee 100 may be directed to take CBT, SIM, or ILT courses, which will generate test scores 102, 104, and 106. The LMS controller 108 may receive the test scores 102, 104, and 106. After receipt the LMS controller 108 may then generate driver performance assessments 110 which reflect a trainees competence in areas which he has completed coursework.

Depicted in FIG. 2 is a training system utilizing an LMS. An LMS system 200 includes a processor 202, a communications device 204, and a storage device 206. An operator may interact with the LMS system 200 through a display 208 and an input device 210. The communications device 204 may be any appropriate communication device, for example an ethernet adapter. Communications through device 204 could take place locally, such as on a local computer system or local area network, or more remotely such as over a wide area network, over the internet, or via wired or fiber optic communication or via wireless transmission. Communications device 204 provides facilities for the reception of trainee data, such as scores and instructor comments, and may also provide facilities for the transmission of trainee data. Communications device 204 may provide further facilities, if desired, such as performance monitoring of the LMS, configuration of the LMS, and other administrative tasks. Display 208 may be a computer monitor, and LCD display, or any other device or combination of devices capable of the display of trainee scores to a human operator. In one system display 208 is a computer monitor connected to the LMS system 200 by a VGA graphics cable. Input device 210 may be any device or devices that permit the entry of trainee registration information into LMS system 200. Examples of input devices are keyboards, mice, trackballs, touchpads, card readers, and optical readers. In one system input device 210 includes a keyboard and a mouse. Storage device 206 contains software local to LMS system 200, and may additionally store the trainee scores, registrations, curriculum information and other information.

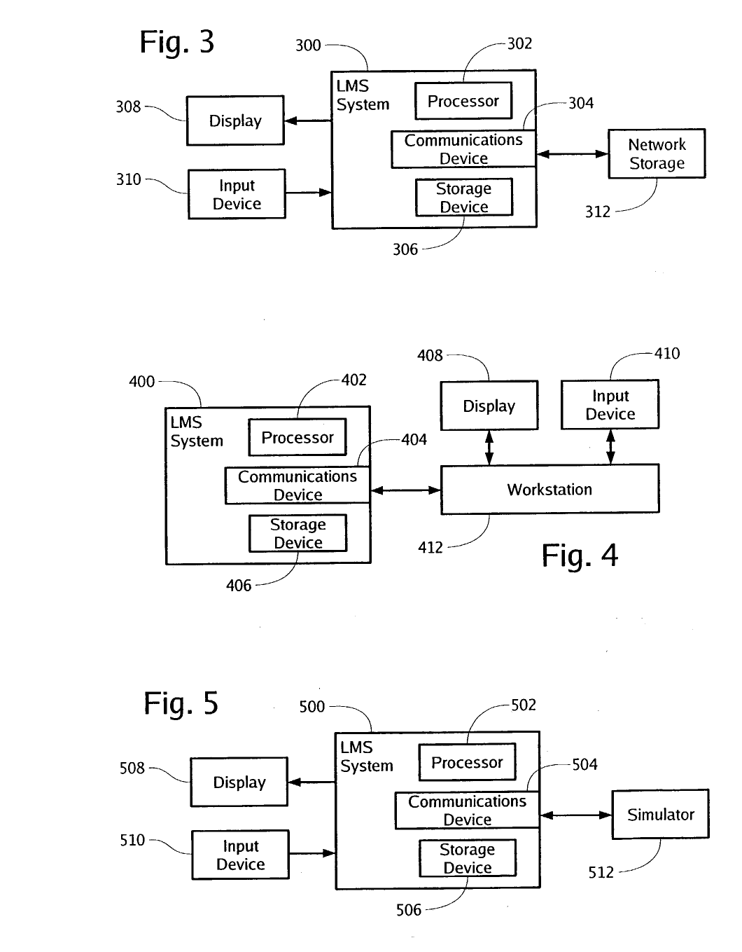

FIG. 3 depicts an alternate system including an LMS system, in which network storage 312 is included. Network storage 312 may contain trainee scores and other trainee information, curriculum information, or software necessary for LMS functions as desired. Elements 300, 302, 304, 306, 308, and 310 may serve the same functions as 200, 202, 204, 206, 208, and 210, respectively, with the exception that some of the data that would have been stored to storage device 206 may be migrated from storage device 306 to network storage 312. In one system, network storage 312 is implemented as a shared network directory on a separate computer. In another system network storage 312 is implemented on a database server. In yet another system network storage 312 is accessible through a custom API to a separate computing device.

Depicted in FIG. 4 is an additional system including an LMS system, in which a display 408 and input device 410 communicate with an LMS system 400 through a workstation 412. In that system workstation 412 contains networking facilities for communication with LMS system 400 through communications device 404. In one system workstation 412 provides a web browser, and LMS system 400 provides an HTTP server for communication of trainee registration and scoring data. Alternatively, remote access may be provided via wireless connection, wired (telephone) connection, fiber-optic connection or any other means for connecting remote trainees with a central system. Processor 402, communications device 404, and storage device 406 serve the same functions as the processors, communications devices, and storage devices of the above described systems.

Referring now to FIG. 5, a system with an LMS system 500 and an accessible simulator 512 is depicted. An LMS system includes a processor 502, a communications device 504, a storage device 506, a display 508, and an input device 510, functioning as in above described systems. A simulator 512 includes a motor vehicular cockpit wherein a trainee will be situated in a training position, and a display upon which computer generated images are viewable by the trainee in the training position. Simulator 512 is capable of producing computer generated images of sufficient quality that a trainee may perceive a virtual reality of driving conditions controlled by controls in the motor vehicular cockpit. Simulator 512 further contains facilities for the automatic scoring of the trainee through a course module, and transmission of the scores to the LMS system 500 through communications device 504.

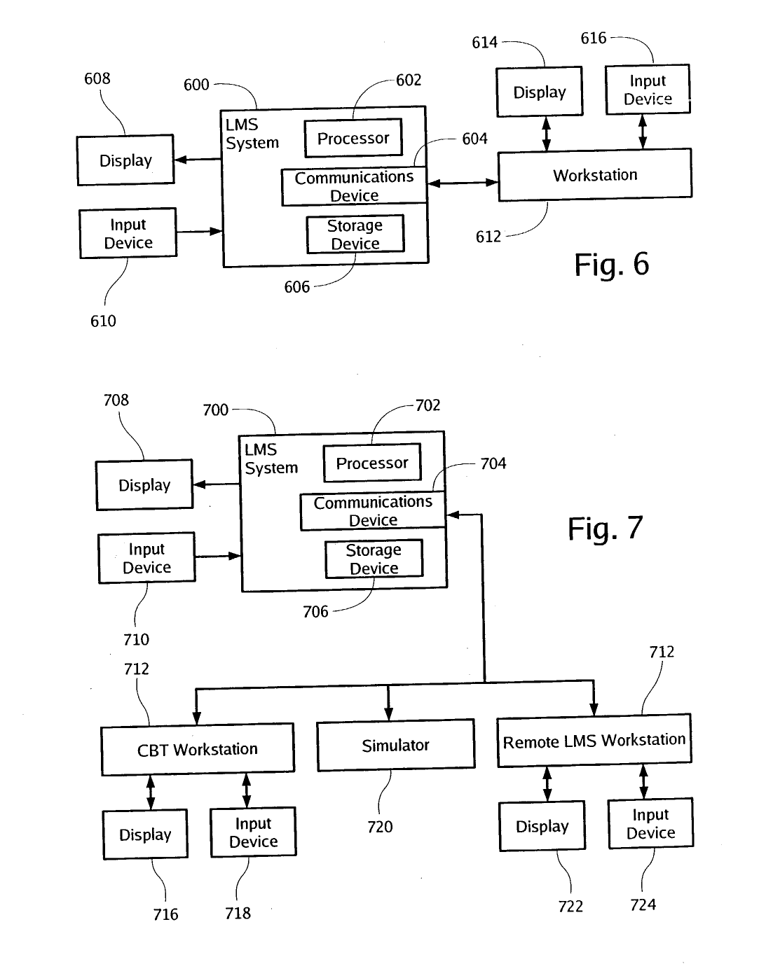

FIG. 6 shows a system including an LMS and two display and input consoles. One local console is formed by display 608 and input device 610. A second remote console is formed by display 614 and input device 616, which are connected and controlled by workstation 612. Elements 600, 602, 604, and 606 serve in similar functionality as systems described above. More than two consoles may be provided in a system including an LMS. In one system communications device 604 is connected to a LAN, thereby including most or all networked computers on the LAN as workstations 612. In another system many local consoles are provided through serial terminal connections to LMS system 600.

FIG. 7 shows a system including an LMS system 700, a simulator 720, a CBT workstation 712, and a Remote LMS Workstation 712. LMS system 700 includes a processor 702, and a storage device 706 which serve to function as in other systems described above. A communications device 704 is connected to a computer network, allowing network communication with CBT workstation 712, simulator 720, and Remote LMS Workstation 712. A local display 708 and input device 710 provides a console for the display and editing of trainee data. CBT workstation 712 controls a display 716 and receives trainee input from an input device 718, and functions to permit computer based training to trainees. CBT workstation 712 may also function as a remote LMS workstation, if desired. Alternate systems may include a CBT workstation attached locally to an LMS system. A Remote LMS Workstation 712, with its display 722 and input device 724, provides access for display and editing of trainee scores, and may also serve to configure LMS system 700.

FIG. 7 illustrates a simple system; systems including multiple CBT Workstations, simulators, or Remote LMS Workstations may often be desirable, as it is generally more economical to train trainees in groups at a single location. Other systems include multiple LMS systems, whereby a simulator interact with more than one LMS. Those systems may be used where it is desirable to keep some trainee data separate from another group of trainee data, or as a backup.

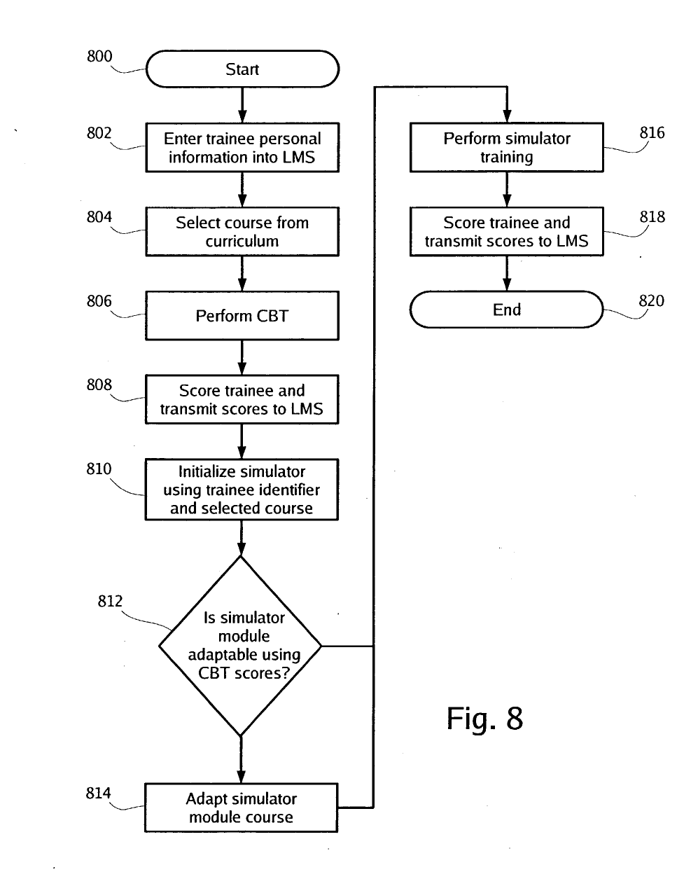

FIG. 8 illustrates a method of training a trainee in courses of a motor vehicular training curriculum. The first step 802 is to enter trainee personal information into a learning management system (LMS). This information might include, for example, a trainee's name, employer, age, operated vehicle types, and an identification number. That information facilitates tracking the status and progress of a trainee through a motor vehicular training curriculum. The next step 804 is to select a course from the curriculum to apply to the trainee. The selection of a course may be made in many possible ways. In one method of training each trainee progresses through a series of courses in a prescribed order. In another method particular courses are selected for a trainee based on his past driving history and performance. For example, a trainee who has recently been involved in a collision might first take a course relating to hazard perception or emergency maneuvers. In a further method a course is selected based on an aptitude or driving test. In yet another method a course may be selected based on scores of previous training in courses of the curriculum, for example if a trainee's scores demonstrated a weakness in an area of skill. Again, many possible methods of selecting a course of training are possible other than as specifically described herein. The order of steps may be changed, steps may be added or omitted, and the nature of various steps may be changed.

Following step 804, next step 806 is performed in which computer based training (CBT) is applied to a trainee in the selected course. During the course of CBT training the step 808 of scoring the trainee is performed, and the scores are transmitted to the LMS. In one method the scoring involves counting correct or incorrect trainee answers to a multiple-choice examination. In a related method scores may be provided for groups of questions that relate to a particular skill or subject. Following that step, step 810 is performed in which a motor vehicular simulator is initialized and prepared for the trainee using a simulator module of the selected course. In one method a trainee identifier is entered at a simulator operator workstation. The workstation then queries the LMS where the trainee information is stored, and identifies the course module to be executed using the trainee identifier as an index. In some methods a simulator module is provided which is adaptable to meet a particular trainee's demonstrated training needs. For example, some simulator modules provide additional practice situations and tests to emphasize and further testing of trainees in particular areas. In a more specific example, a truck driving simulation module may provide optional additional simulated vehicles which wander out of their lanes. If prior testing of a trainee demonstrated a possible deficiency in coping with wandering vehicles, those optional vehicles would be selected to be present. The adaptation of a simulator module may in some cases be automatic, based on a trainee's CBT scores. In other cases the adaptation is manual, requiring some input and decision of a simulator operator or instructor. In other cases, the training may be canned predetermined scenarios for each subject matter.

In step 812 it is decided whether or not a simulator module of the selected course is adaptable. If it is adaptable, step 814 provides for that adaptation. The simulator equipment may query the LMS to receive the scores of a particular trainee, and may additionally automatically adapt the simulation module using the scores without operator intervention. Regardless of whether the simulator module is adaptable, simulator training using the simulator module of the selected course is performed in step 816. The trainee's simulator performance is then scored, and the score information sent to the LMS in step 818. Further training may then be performed, as desired.

In some methods, a simulator is used which automatically scores a trainee's performance. Manual scoring is also possible. Automatic scoring is possible at many levels. For example, a simulator may detect collisions of the virtual trainee vehicle to other simulated vehicles, and reflect those collisions in scoring. In another example, a simulator may monitor the speed of the virtual training vehicle and compare the speed to limits, the score reflecting deviations of the trainee's vehicle speed from the permitted range. In a further example, a simulator may monitor the fuel consumption of the virtual trainee vehicle, the scoring reflecting the trainee's efficient use of fuel.

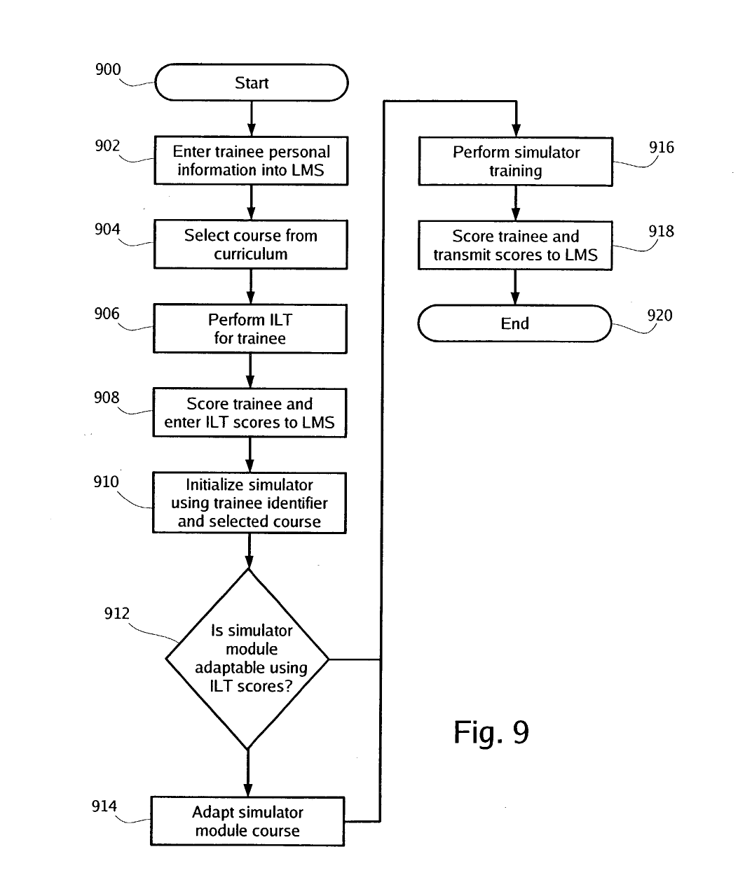

Depicted in FIG. 9 is another method of training a trainee in a curriculum of motor vehicular training courses. The first step 902 is to record trainee information into an LMS. The next step 904 is to select a course from the curriculum, as described in the discussion of FIG. 8. Next, instructor led training in the selected course is performed in step 906, which involves training using an instructor. During the course of that training the trainee may be scored, noted in step 908. That scoring might be, for example, a written examination or comments from an instructor based on interaction with a trainee. Further in step 908, those scores are transmitted to an LMS, and stored thereat. Simulator training may then commence. In step 910 a simulator is initialized to a simulator module of the selected course. The simulator module may be identified, for example, by receiving a trainee identifier, querying an LMS for a course using the identifer, and receiving a selection of a course. In this method some simulator modules may be adaptable to a specific trainee based on the ILT scores of that trainee. If the test of step 912 is positive, indicating that the simulator module is adaptable, the simulator module is adapted in step 914. Step 916 is then executed, in which the trainee is trained in the simulator using the simulator module. During the course of that training the trainee receives a score, in step 918. That score may then be transmitted to an LMS for inclusion into the trainees records, also shown in step 918.

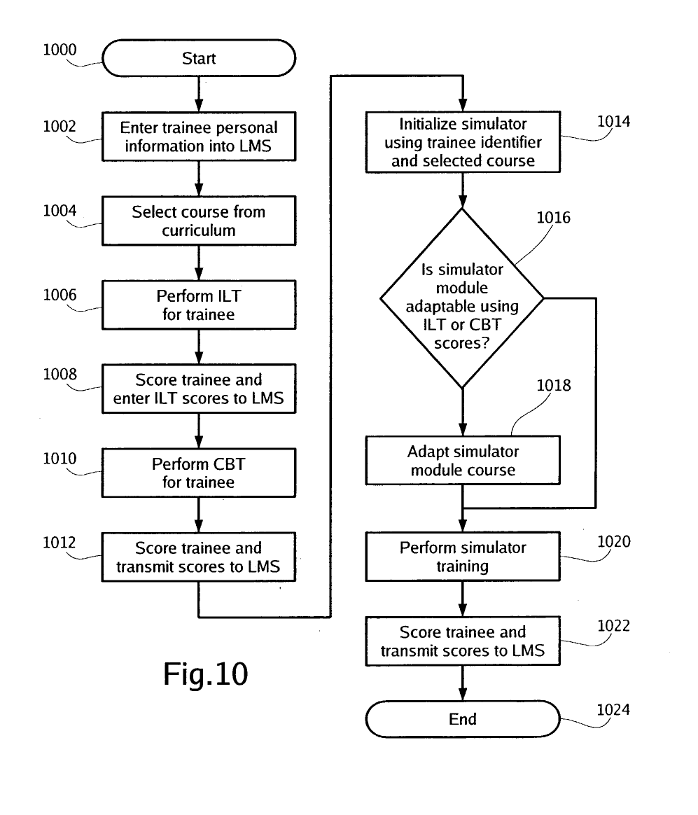

Referring now to FIG. 10, another method of training a trainee in a curriculum of motor vehicular training courses is illustrated. First, trainee personal information is entered into an LMS, as in step 1002. This again would include an identification of each trainee to be trained. In step 1004, a course is selected from the curriculum, discussed above. The method of FIG. 10 includes the steps of ILT training 1006 and CBT training 1010, including resultant scoring and transmission of scores to an LMS in steps 1008 and 1012. Step 1014 is performed afterward, which initializes a simulator to a simulator module of the selected course. If the simulator module is adaptable using the ILT or CBT scores, as determined in step 1016, step 1018 is performed adapting the simulator module. In step 1020 simulator training is provided for the trainee. Finally, the trainee receives scores based on his performance on the simulator module and the scores are sent to the LMS, step 1022.

Included in the inventive concepts are methods and systems which may receive trainee scores from an LMS and apply adaptations to CBT training. For example, a trainee may be tested in a simulator, providing scores based on the trainee's natural behavior in situations of interest. Those scores may then be applied to computer based training. In one example, the CBT training includes additional material emphasizing the correct behavior in the areas of trainee behavior demonstrated to be deficient in the simulator. In another example, additional examination questions are directed to the deficient area. In yet another example, material from other CBT courses relating to the area of deficiency are included in the next CBT course.

In further examples, a simulator module may be adapted for a trainee using scores from prior simulator based training. In some of those systems, a simulator module may be adapted to a difficulty level based on previous simulator scores. In yet other systems, a simulator module may be adapted to a difficulty level based SIM, ILT, and CBT scores, or combinations of the three and possibly other scores. Additionally, it will often be useful to utilize CBT and simulator scores in ILT, such that an instructor may emphasize areas of deficiency exposed in the CBT and simulator training. CBT scores may be a benchmark to assess performance improvement or whether additional training is necessary. The scores may be a guide to the types of additional training needed, they may be a pre-hire assessment or they can serve as an industry knowledge test. CBT scores can be used for risk assessment, and for psychological profiling of current or prospective drivers.

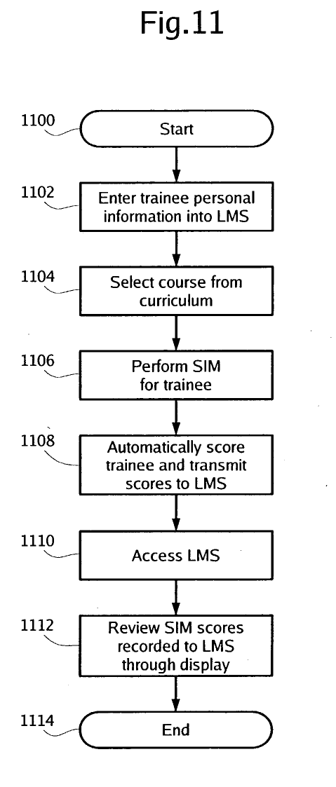

FIG. 11 depicts another method of training a trainee in a curriculum of motor vehicular courses using a simulator and an LMS. First, in step 1102 trainee personal information is entered to the LMS. That information may include an identifier for tracking a trainee and other information useful for adapting training courses, billing, and other purposes as desired. Step 1104 is performed, selecting a course from the curriculum, as discussed above. In step 1106 simulator training is applied to the trainee, using a simulator module of the course selected in step 1004. During the simulation training, the trainee's performance may be scored automatically, or may be manually scored by an instructor, or both. Those scores are then sent to the LMS, where they are stored for future retrieval, in step 1108. An instructor, for example, may then access the scores contained on the LMS system, shown in step 1110, and review the trainee's simulation scores using a display of the LMS, as in step 1112. The instructor may then decide future participation in the curriculum, perhaps passing the trainee or recommending a repeat training in the selected course.

In some LMS systems access to the scoring results is made accessible to employers of the driving trainees. In some of those systems the trainee data is culled to provide an overview to the employer. In one specific example, the LMS includes an HTTP server permitting access through the Internet by a browser. In that example authentication facilities are provided so as not to transmit data to those who are unauthorized. The HTTP server may include CGI facilities, or other executable facilities for producing dynamic output. In other exmples the trainee data is stored to a database server, accessible to an LMS and a web server that reads the data and produces reports. In yet other examples trainee data is automatically purged after a period of time, such as 12 months to reduce the possible damage and liability of a security break-in.

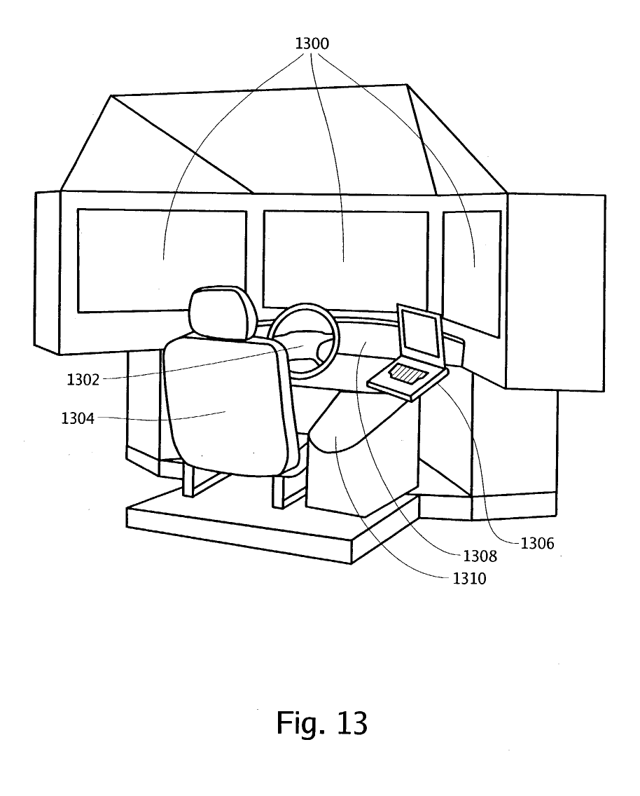

FIG. 13 depicts an example simulator system suitable for training law enforcement personnel in the operation of interceptor motor vehicles. The simulator includes three displays 1300 providing a wide angle view of a simulated environment. A seat 1304 provides a normal position for the trainee while operating the virtual interceptor. A steering wheel 1302 and other controls are provided which duplicate the controls of an interceptor, or reflect the controls of various types of interceptor motor vehicles in general. A computer 1306 may be provided, duplicating the equipment utilized in many police vehicles at the present time. An indicator panel 1308 contains expected indicators that would normally be in the cockpit of an interceptor vehicle, such as a speedometer, tachometer, idiot lights, and other indicators. The indicators may be operable by the simulation equipment to reflect the conditions of the virtual vehicle in the simulation. A center column 1310 may be provided, and may contain other controls such as police radio controls.

In some systems, course modules are provided on transportable media, such as CD-ROMs. In other systems, course materials are provided over a network, for example by a network drive or by a transfer protocol such as FTP or HTTP.

An example is provide below in which an LMS tracks trainees coursework and performance scores. In the example curriculum a scope of content may be provided having 21 subject matter domains (or more or less depending on preference), which may define individual courses:

Speed Management for Tractor-Trailers

Space Management for Tractor-Trailers

Backing and Turning for Tractor-Trailers

Speed and Space Management for Non-articulated Vehicles

Adverse Driving Conditions

Emergency Maneuvers

Pre-trip Inspection for Tractor-Trailers

Hours of Service

Hazardous Materials

Incident Response

Circles of Influence

Fuel Management

DUI Recognition

Shifting Techniques

Driver Wellness

Perishable Skills

Hazard Perception

Intersection Analysis

Pursuit Intervention Technique (PIT) Maneuvers

Pursuit Management

First Responders' Procedures

In that curriculum the 21 subject matter domains may be customized for 11 distinct vehicle types to produce 94 courses. Those 11 vehicle types are:

Tractor-Trailers

Straight Trucks

Municipal Trucks

Delivery Trucks

Motor Coaches

Transit Buses

School Buses

Police Cars

Ambulances

Fire Engines

Sedans and Vans

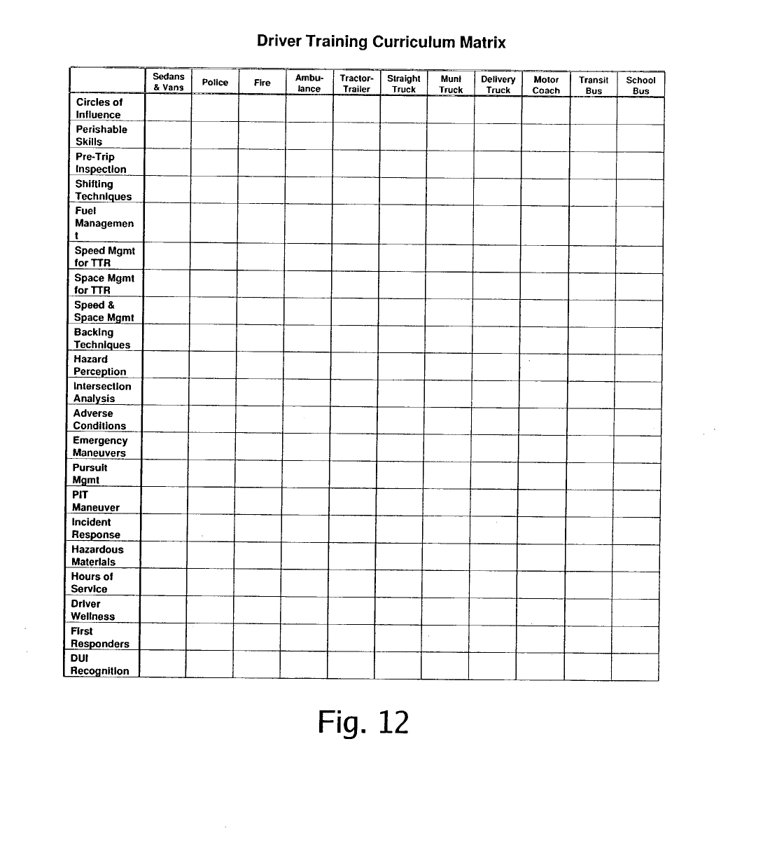

A table illustrating a matrix of courses to matter domain and vehicle types of the example curriculum appears in FIG. 12. A match of any course to any vehicle type could be provided.

In the example curriculum, a course may be typically designed to be delivered within a two hour time frame. Each of those courses may be modularized into multiple ILT, SIM, and CBT sessions and may be managed jointly by an instructor and an LMS if desired.

In the example curriculum, each course may include an Instructor's Guide, which may include the following:

A detailed content outline of the course

The learning objectives of the course

A detailed course schedule

An overview of course modules

A detailed course syllabus

A detailed description of each module

Lecture notes for instructor-led modules

In-class learning activities

Job aids suitable for copying and distribution

A narration script for each CBT module

The text of embedded, practice, and objective questions with answer keys

A detailed description of included simulation scenarios

A glossary of terms

A generic approach to teaching adult learners

Operating instructions for CBT and SIM modules.

Operating instructions for an LMS.

Each course of the example curriculum may also provide a presentation of a number of frames, for example 10-20 frames, including both graphical and textual materials whenever they are useful to convey the desired subject matter to students.

In the example curriculum, CBT modules are presented in a true-color, highly texturized two-dimensional stylized electronic interface designed for ease of use by those who are not computer literate. Shading and line configuration may be used to create a three-dimensional appearance on the two-dimensional screen. The user interface further presents in a three-dimensional style mortise with up to three separately controllable regions: the main display, the sub display, and a scrollable menu. Three-dimensional style navigation buttons provide for movement in the training session, the buttons controlling next, repeat, back, map and menu functions. Each of those buttons may have the states of neutral, mouseover, working, and disabled. Three-dimensional style menus may be provided with three button states: neutral, mouseover, and checked-off for completion. A globally active course map may show the content organization and menu structure with the trainee location highlighted.

In those CBT modules a generic main menu may be provided with four subdivisions: an introduction, an instruction area, practice questions, a written examination. A menu provides for movement to those subdivisions, or to exit the module altogether. The organization of those CBT modules may provide for a heirarchical content specific menu structure up to five levels deep. The introduction subdivision may contain a one to two minute specific introduction to the content of the CBT course module, and a generic interactive tutorial of seven to eight minutes of live action video of a host character explaining how to navigate through the lesson. The instruction area subdivision may be generally composed of 10 to 15 sequences of approximately one to five minute segments, which include a mixture of material including: still-frame audio, live-action video and animation, 15 to 30 embedded questions distributed throughout the instructional sequences, practice exercises with five to ten problem-solving interactions, and a written examination with 15 randomized objective questions.

For question and answer screens of CBT modules of the example curriculum, each screen may include a narrated question stem, a graphic, and up to four answer choices on foils with associated buttons, and a submit button. A trainee may also change his answer selection at will prior to submission. Mouseover and selected button states may be made available for each answer foil. For written examinations (typically delivered in electronic format on a computer screen), the group of presented questions may be randomized for each examination presentation to a trainee. Additionally, the order of answer choices is randomized after each incorrect submission. The next button is disabled upon an incorrect answer selection and enabled after selection of a correct answer. Randomized audio sound effects can provide both positive and negative feedback to the trainee's selections. A question counter set in a mortise may be provided which shows the progress of the trainee through an examination. Simulated LED text and pilot lights are also provided in the question counter mortise indicating correct and incorrect answer choices through red and green indicators.

Where included, those CBT modules may also provide three-dimensional cutaway models of vehicles implemented as video virtual-reality sequences allowing 360° rotation and zoom functions controlled by three-dimensional style on-screen buttons. In some modules moving highlights may be included identifying 50 inspection points on three-dimensional models linked to close-up views of parts. In those modules about 30 percent of the inspection points may be randomly selected to have faults at the initiation of each session. In those modules text may be moved from virtual paperwork to locations through a drag-and-drop operation. If incorrectly placed, that text may snap back to the virtual paperwork, or may stick to correct locations. A line draw function with similar “snap or stick” characteristics may also be provided for diagramming driver log pages.

In an example system, video is displayed at 30 frames per second using true-color in a 500 by 700 pixel window. In that system navigation of all material of the CBT module is controllable through next, repeat, and back buttons.

An installation security system may be included in those CBT modules that generates a first code upon installation that must be matched by a counter-code generated by a headquartered computer, the first code being generated from unique seed information provided by the hard disk, program, and time of the installation.

In an example system, a learning management system may be accessible through a network, such as a local area network, a wide area network or the internet with an HTTP server operating thereon. The server provides for communication using browsers on separate workstations, or the same workstation which operates the learning management system. Each web page contains global links to “home”, “register new driver”, “view/select driver”, “course catalog”, “view schedule”, “help”, and “feedback”. That LMS may provide for the viewing of the Driver Development Services (DDS) curriculum, and displays (1) all vehicle programs, such as Tractor-Trailer, Sedans & Vans, etc., (2) the name and number of all courses included in each vehicle program, such as speed management, hazard perception, etc., (3) catalog descriptions of each course within each vehicle program, and (4) modular course schedules, with default times assigned to each ILT, CBT and SIM module of each course.

In that LMS, registration facilities are provided for registering customers/companies and instructors. Trainees may become registered through hand data entry or in batches through database or spreadsheet files. The data fields provided for trainee registration may include (1) company identification, (2) a first and last name, (3) the trainee's address, city, state, and zip code, (4) the social security number of the trainee, (5) the drivers license number of the trainee, (6) a badge number, (7) a department name, (8) a job title, and (9) a training location.

In that LMS, the data collection of registered drivers may be viewed and modified. That LMS can display the last five drivers registered. It can additionally search using a trainee name, identification number, company, and training location. That LMS can also provide for the display and modification of all trainee registration information and course assignments.

That LMS can also launch CBT and SIM modules, and may display the CBT and SIM modules that are assigned to a trainee upon entry of an identification number. That LMS can provide for launching of appropriate CBT and SIM modules for each course to which a trainee is assigned.

Additionally, that LMS may collect trainee performance data from ILT, CBT, and SIM modules. For CBT modules, the LMS may collect practice exercise scores, and written examination scores. For SIM modules, the LMS may collect data such as the average miles per gallon fuel efficiency, the average speed in the scenario, the maximum speed, and specific violations which depend on the individual simulation course module. For ILT modules, the LMS may collect instructor observations and assessments of trainees, perform driver scoring, and other custom scoring parameters that may be made available.

That LMS may also provide viewing and modification of driver performance information on a per course basis. That LMS may display trainee performance data for ILT, CBT, and SIM modules that have been completed. That LMS may additionally display and modify the completion status and score percentages for all ILT, CBT, and SIM modules included in each course. Two or more scores could be reported for each ILT, CBT and SIM module. That LMS may also display and modify score details and instructor comments on any ILT, CBT and SIM module completed. The date of last use of each course module may also be displayed. That LMS may also generate a performance report containing information on a per course basis, including (1) the course name and number, (2) the trainee's identification number, (3) the trainee's company I.D., (4) the time and date of course delivery, (5) the location where the course was delivered, (6) the completion status, and (7) all scores and instructor comments.

That LMS may also capture and report trainee feedback through an on-line input form. The trainee feedback may be displayed and sorted by the information of the fields, the fields including (1) a date or range of dates, (2) the location or locations where training occurred, (3) the instructors who taught the course, (4) a company I.D, and (5) a course I.D. That LMS may create a trainee feedback report which may be printed of emailed, in a textual or a graphical format.

That LMS also has a help system containing instructions directed to the operation of the LMS. For example, instructions are provided for (1) trainee registration, (2) log-on procedures for learning lab computers, (3) the display of curriculum, courses and course structures, (4) viewing and editing trainee performance data, (5) launching the feedback input forms, (6) generating feedback reports, and (7) downloading and updating LMS software modules.

While the present systems and methods have been described and illustrated in conjunction with a number of specific elements and capabilities, those skilled in the art will appreciate that variations and modifications may be made without departing from the principles herein illustrated, described, and claimed. The present invention, as defined by the appended claims, may be embodied in other specific forms without departing from its spirit or essential characteristics. The specific elements and capabilities described herein are to be considered in all respects as only illustrative, and not restrictive. All changes which come within the meaning and range of equivalency of the claims are to be embraced within their scope.

1. A learning and management computer system for training trainees in a curriculum of motor vehicle training courses, comprising:
a processor system including a processor;
a computer communications device included in said processor system whereby information may be communicated to said processor system,
a display controllable by said processor system;
at least one input device whereby a user may provide input to said processor system;
at least one storage device accessible by said processor system;
computer instructions stored to said storage devices, said instructions being executable by said processor system to achieve the functions of:
(i) registering a trainee,
(ii) tracking a trainee in the curriculum,
(iii) receiving performance scores from simulation based training systems through said computer communications device,
and (iv) viewing performance scores through said display.

2. The system of claim 1, wherein the computer instructions are further executable by said processor system to achieve the function of editing trainee data through said display and said input devices.

3. The system of claim 1, wherein the computer instructions are further executable by said processor system to achieve the function of receiving computer based training scores.

4. The system of claim 1, wherein the computer instructions are further executable by said processor system to achieve the function of receiving instructor led training scores.

5. The system of claim 1, further comprising:
at least one computer based training system, said computer based training systems having facilities for testing a trainee in computer based training courses of the curriculum, said computer based training systems further having facilities for communicating training course test results of a trainee to said processor system.

6. The system of claim 1, further comprising:
at least one vehicular simulator system, said vehicular simulator systems having facilities for testing a trainee in simulator based training courses of the curriculum, said vehicular simulator systems further having facilities for communicating training course test results of a trainee to said processor system.

7. The system of claim 6, wherein:
said processor system is operable to transmit course adaptation information to said vehicular simulator system;
said vehicular simulator system is operative to receive adaptation information from said processor system;
and said vehicular simulator system is further operative to adapt simulation courses according to received adaptation information.

8. The system of claim 7, wherein:
said processor system is operable to transmit a level of difficulty to said vehicular simulator system;
and said vehicular simulator system is operative to adapt the level of difficulty of the simulation courses.

9. The system of claim 7, wherein said vehicular simulator system is operative to automatically score a trainee taking a course of the curriculum.

10. The system of claim 1, wherein said computer communications device is a network adapter permitting electronic communication over a computer network.

11. The system of claim 1, wherein the computer readable instructions are further executable by said processor system to achieve the function of providing trainee reports to an employer over a network.

12. The system of claim 1, wherein the computer readable instructions are further executable by said processor system to achieve the function of automatically purging data relating to a trainee following a period of time during which the trainee has not been trained.

13. A vehicular training system for training trainees in a curriculum of motor vehicle training courses, comprising:
an LMS, said LMS having a processor, said LMS further having computer storage whereby trainee registration information and course tracking information may be stored, said LMS further having a computer communications facility whereby course tracking information may be received from vehicular simulator systems;
at least one vehicular simulator system, said vehicular simulator system having a trainee cockpit in the likeness of a vehicle or vehicle type, said vehicular simulator system further having a display whereby a trainee may view computer generated images simulating driving views, said vehicular system further having an automatic scoring function, said vehicular system additionally having a computer communications facility whereby scores generated by the automatic scoring function may be communicated to said LMS.

14. The system of claim 13, wherein the computer communications facility of said LMS can also receive course tracking information from computer based training systems.

15. The system of claim 13, wherein the computer communications facility of said LMS may also receive course tracking information from instructors.

16. A method of training a trainee to operate motor vehicles in a curriculum of courses, each course having application to at least one particular driving skill related to a particular vehicle or vehicle type, said method comprising the steps of:
identifying a trainee;
identifying a course in the curriculum to apply in training of the identified trainee;
training the identified trainee using a vehicular simulator, said training utilizing a simulator module of the identified course;
generating automatic scores during said training by the vehicular simulator;
and transmitting the automatic scores to a learning management system.

17. The method of claim 16, wherein said identifying a course uses trainee data stored on a learning management system.

18. The method of claim 16, wherein said identifying a trainee utilizes a trainee identification number.

19. The method of claim 16, further comprising:
training the identified trainee using a computer based training system;
generating CBT performance data for the identified trainee as a product of the computer based training;
and transmitting the CBT performance data to the learning management system.

20. The method of claim 19, further comprising:
entering a trainee identification number;
identifying a CBT module of the curriculum for which the trainee should be trained;
and said training using a computer based training system uses the identified CBT module.

21. The method of claim 16, further comprising:
providing instructional based training to the trainee;
and entering CBT performance data to the learning management system.

22. The method of claim 16, further comprising:
reading previous automatically generated scores from a learning management system;
determining a level of difficulty;
and wherein said training utilizes the determined level of difficulty.

23. A system for providing motor vehicle learning management, the system comprising:
an LMS system,
CBT, SIM and ILT instruction modules for instructing students in the safe handling of a ground motor vehicle,
performance scoring capability for scoring a student's performance in said CBT, SIM and ILT instruction modules to produce performance results,
said performance results being provided to said LMS controller through said communications device in order to permit evaluation of student performance.

24. A system as recited in claim 23 further comprising automated scoring of student performance of CBT and SIM curriculum modules.

25. A system as recited in claim 24 further comprising automated tailoring of curriculum based on said performance results.

26. A system as recited in claim 23 further comprising remote communications capability between said LMS and said CBT, SIM and ILT curriculum modules.

27. A system as recited in claim 26 wherein said remote communications capability is selected from the group consisting of wireless communications, wired communications, fiber-optics, internet, and wide area network.

28. A method for providing tripartite motorized ground vehicle learning management comprising the steps of:
identifying a student,
selecting a course from a set of predetermined curriculum,
performing CBT with said student,
scoring said student's performance on said CBT,
performing SIM with said student,
scoring said student's performance on said SIM,
performing ILT with said student,
scoring said student's performance on said ILT, and
evaluating said student's performance.

29. A method as recited in claim 28 further comprising at least one of said CBT and said SIM being adaptable based on said student's score on the other of said SIM or said CBT, and adapting curriculum based on said student's score.

30. A method for providing tripartite motorized ground vehicle learning management comprising the steps of:
identifying a student,
performing CBT with said student,
scoring said student's performance on said CBT,
performing SIM with said student,
scoring said student's performance on said SIM,
performing ILT with said student,
scoring said student's performance on said ILT, and
evaluating said student's performance.

31. A method as recited in claim 30 further comprising adapting said CBT based on said student's performance in at least one of said ILT and said SIM.

32. A method as recited in claim 30 further comprising adapting said SIM based on said student's performance in at least one of said ILT and said SIM.

33. A method as recited in claim 30 wherein at least one of said CBT and said SIM is adapted based on said student's performance in said CBT or SIM as said student progresses through said CBT or SIM.

34. A method for providing tripartite motorized ground vehicle learning management comprising the steps of:
identifying a student,
having said student complete CBT, SIM and ILT curriculum modules,
electronically scoring said student's performance in both said CBT and said SIM modules,
adapting at least one of said CBT or SIM curriculum modules based on said student's score in either of said CBT or SIM modules.
